(19) United States
(12) Patent Application Publication
(10) Pub. No.: US 2025/0315505 A1
(43) Pub. Date: Oct. 9, 2025

(54) USING SENSED INFORMATION FROM DIFFERENT TYPES OF SENSORS

(71) Applicant: AUTOBRAINS TECHNOLOGIES LTD, Tel Aviv-Yafo (IL)

(72) Inventor: Omer Jackobson, Tel Aviv (IL)

(73) Assignee: AUTOBRAINS TECHNOLOGIES LTD, Tel Aviv-Yafo (IL)

(21) Appl. No.: 18/627,440

(22) Filed: Apr. 4, 2024

(51) Int. Cl. G06F 18/25; B60W 60/00

(52) U.S. Cl. CPC G06F 18/25; B60W 60/001; B60W 2552/20; B60W 2556/35

(57) ABSTRACT

A computer-implemented method for sensor fusion in relation to at least partially autonomous driving of a vehicle. The method may include obtaining first signatures of first patches of a first type sensed information unit (SIU) that was sensed by a first sensor of a first type; obtaining second signatures of second patches of a second type SIU that was sensed by a second sensor of a second type, the second type differs from the first type; wherein the first sensor and the second sensor are associated with the vehicle; finding correlations by applying a correlation function between the first signatures and the second signatures; wherein the finding is executed by a mapping system; and determining, based on the correlations and by the mapping system, a mapping between the first patches and the second patches, the mapping to be used in an at least partially autonomous driving of a vehicle; wherein the correlation function having been developed by applying a supervised machine learning process based on relationships between members of training signature pairs, each training signature pair comprises a first sensor training signature and a second sensor training signature of a same object.

### BACKGROUND

Assessing an environment of a vehicle is required for autonomous driving of ground autonomous vehicles (AVs) and for advanced driving assistance system (ADAS) operations.

It may be beneficial to use information sensed by different types of sensors, as one type of sensor may have strengths that may compensate for a weakness of another type of sensor.

Using information from different sensors may be inaccurate as the different types of sensors may be misaligned and/or operate differently-which may lead to errors.

There is a growing need to provide an accurate and efficient method for using information from different types of sensors.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a method;

FIG. 4 illustrates an example of a method;

FIG. 5 illustrates an example of a method;

FIG. 6 illustrates an example of a vehicle; and

FIGS. 7-10 illustrates examples of sensed information units, signatures and other information elements.

### DESCRIPTION OF EXAMPLE EMBODIMENTS

According to an embodiment there is provided a method for sensor fusion that determines which patches of different sensed information units (SIUs) of different types should be fused to each other.

The method uses a correlation function that has been developed by applying a supervised machine learning process based on relationships between members of training signature pairs, each training signature pair includes a first sensor training signature and a second sensor training signature of a same object.

Such a correlation function is highly accurate—as it is based on actual information-and being based on a machine learning process—it is capable of capturing relationships that can not be captured by other means.

Calculating an accurate correlation functions greatly simplifies the calculation of correlations between signatures related to SIUs of different types—as there is no need to perform extensive real time adjustments to the correlations calculation.

The method exhibited a reduction of at least 10, 20, 30 percent or more of computational resources—and even a higher reduction of computational resource is obtained when selecting which patches should have their signatures correlated to each other—as illustrate din method 11.

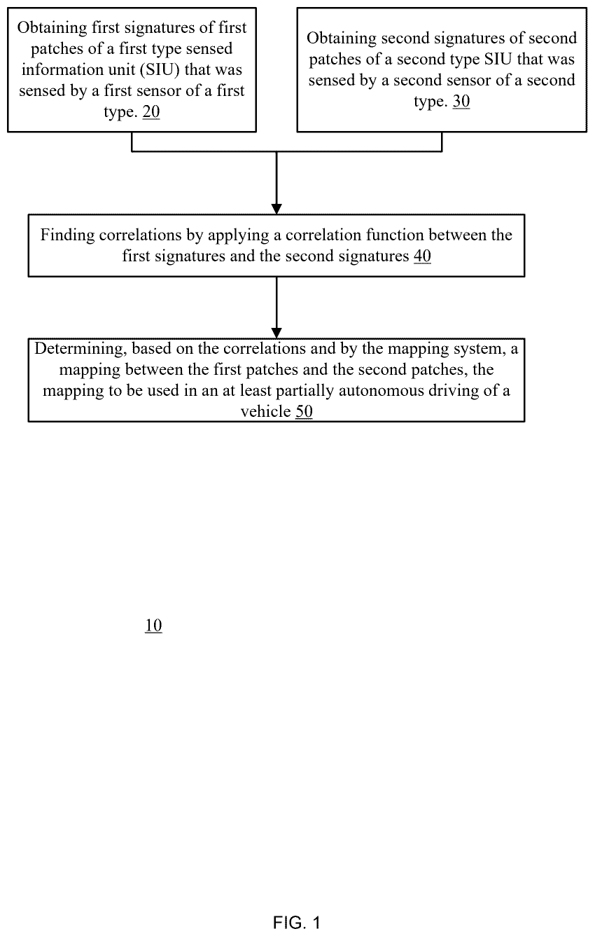

FIG. 1 illustrates an example of a method 10 for sensor fusion in relation to at least partially autonomous driving of a vehicle.

According to an embodiment, method 10 starts with steps 20 and 30.

According to an embodiment, step 20 includes obtaining first signatures of first patches of a first type sensed information unit (SIU) that was sensed by a first sensor of a first type.

According to an embodiment, step 30 includes obtaining second signatures of second patches of a second type SIU that was sensed by a second sensor of a second type. The second type differs from the first type. The first sensor and the second sensor are associated with the vehicle in the sense that that may be part of the vehicle, included in the vehicle, attached to the vehicle, sense the environment of the vehicle, and the like.

The sensors of the different types may differ from each other by representation spaces or axes of their coordinate systems.

Examples of sensors of first and second type include a pairs of sensors out of a visible light camera, a radar, an infrared sensor, a LIDAR, and the like.

According to an embodiment, step 20 and step 30 are followed by step 40 of finding correlations by applying a correlation function between the first signatures and the second signatures.

The correlation function having been developed by applying a supervised machine learning process based on relationships between members of training signature pairs, each training signature pair includes a first sensor training signature and a second sensor training signature of a same object.

According to an embodiment, step 40 is followed by step 50 of determining, based on the correlations and by the mapping system, a mapping between the first patches and the second patches, the mapping to be used in an at least partially autonomous driving of a vehicle.

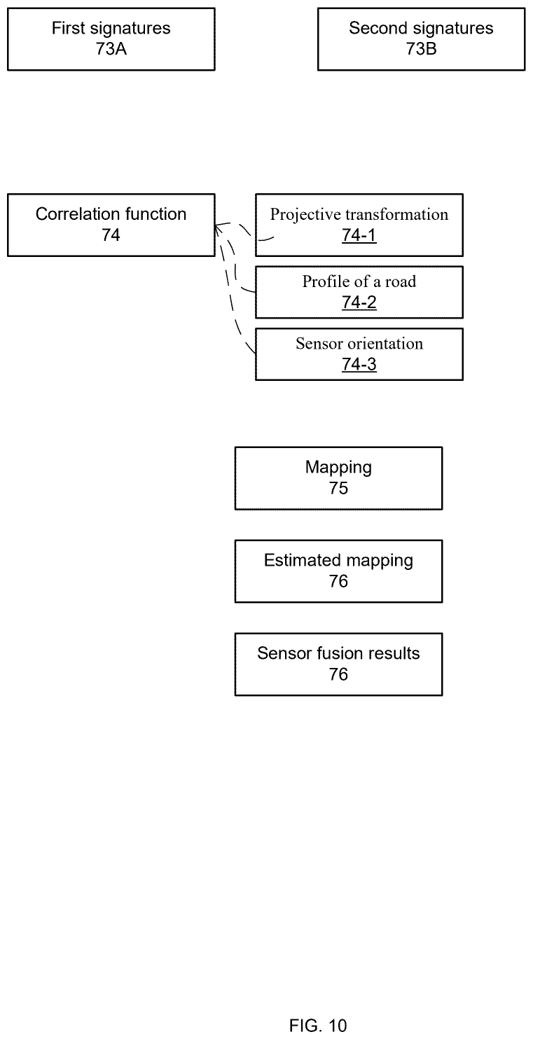

According to an embodiment, step 50 includes determining a projective transformation. The projective transformation (denoted 74-1 in FIG. 10) may be represented by a matrix such as a four by three matrix.

According to an embodiment, step 50 also include determining at least one of:
A profile of a road (denoted 74-2 in FIG. 10) on which the vehicle propagates. The profile may be indicative of the shape of the upper surface of the road—for example flatness, inclination, tilt curvature, and the like.
Sensor orientation information (denoted 74-3 in FIG. 10)—that may include at least one of a first sensor orientation parameter and a second sensor orientation parameter.

It should be noted that a sensor information is not sensitive to the sensor orientation parameter than the orientation parameter of that sensor is less relevant. For example—radar information is less sensitive to the orientation of the radar in comparison to the sensitivity orientation of the image sensor.

According to an embodiment, in order to reduce the among of computations—instead of calculating correlations between each patch of the first SIU and each patch of the second SIU—the method may include selecting which patches should have their signatures correlated with each other. This may dramatically decrease the computational resources and/or memory resources required to execute step 40. The reduction may be by at least a factor of 1, 5, 10, 20, 50, 100, 500 and more.

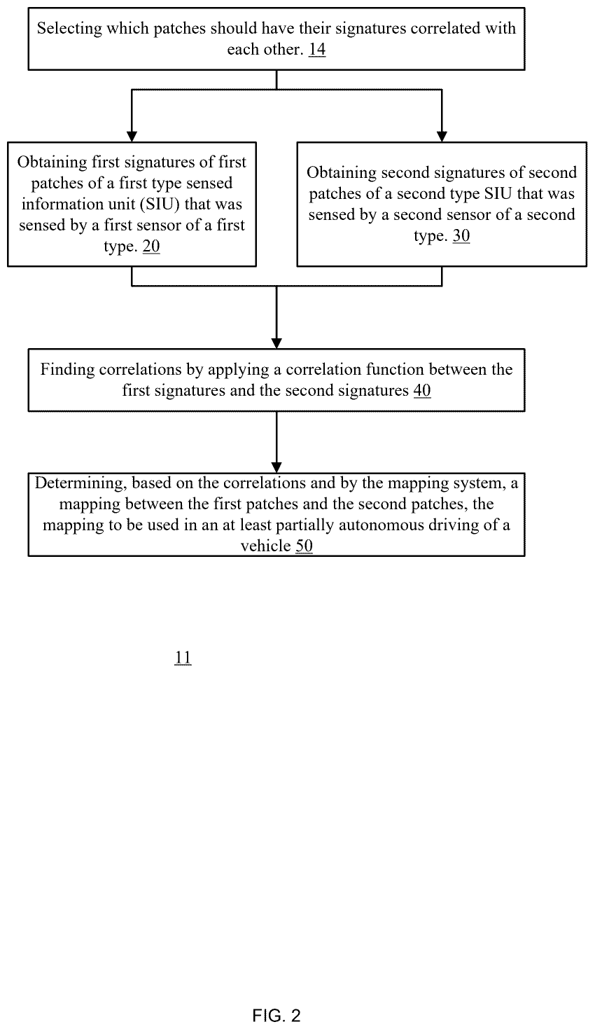

FIG. 2 illustrates an example of a method 11 for sensor fusion in relation to at least partially autonomous driving of a vehicle.

According to an embodiment, method 11 includes step 14 of selecting which patches should have their signatures correlated with each other. The selection may be based on an estimated mapping between the first patches and the second patches.

The estimated mapping may be based on at least one of:
Mappings that were previously used—for example during one or more iteration of step 50.
A raw homography between the first type sensor and the second type sensor.
An initial annotation of corresponding landmarks in the first type SIU and the second type SIU.
An outcome of a calibration process between the first sensor and the second sensor.

For example, assuming that the estimated mapping maps the q'th first patch to the r'th second patch—then the step 14 may determine to correlate the signature of q'th first patch and signatures of his neighbors to the signature of the r'th second patch and the signatures of his neighbors.

In this case the signature of the q'th first patch and the signatures of his neighbors are not correlated against signatures of second patches outside the r'th second patch and his neighbors.

The size of the neighborhood of each of the patches may be selected in any manner—to provide different tradeoffs between usage of resources (which mandate smaller neighborhoods) and the chances of missing relevant information (which may mandate larger neighborhoods).

Step 14 is followed by steps 20 and 30.

According to an embodiment, step 20 includes obtaining first signatures of first patches of a first type sensed information unit (SIU) that was sensed by a first sensor of a first type.

According to an embodiment, step 30 includes obtaining second signatures of second patches of a second type SIU that was sensed by a second sensor of a second type. The second type differs from the first type. The first sensor and the second sensor are associated with the vehicle.

According to an embodiment, step 20 and step 30 are followed by step 40 of finding correlations by applying a correlation function between the first signatures and the second signatures.

According to an embodiment, step 40 is followed by step 50 of determining, based on the correlations and by the mapping system, a mapping between the first patches and the second patches, the mapping to be used in an at least partially autonomous driving of a vehicle.

Any one of method 10 and 11 may include performing the sensor fusion, based on the mapping between the first patches and the second patches.

The mapping defines the contents associated with the first patches to be fused with contents of corresponding second patches.

The fusion may be regarded as a low-level fusion—as the fusion may be executed before object detection is made—in contrary to a high-level fusion a first conclusion about a presence of an object that is based on the first type SIU, with a second conclusion about a presence of the object that is based on the second type SIU.

The low level fusion is more accurate that the high-level fusion as it is applied before reaching to object detection conclusions—and also provide a reduction in memory and/or computational resources—as the method does not execute two separate processes of generating object detection conclusions—and the fusing them.

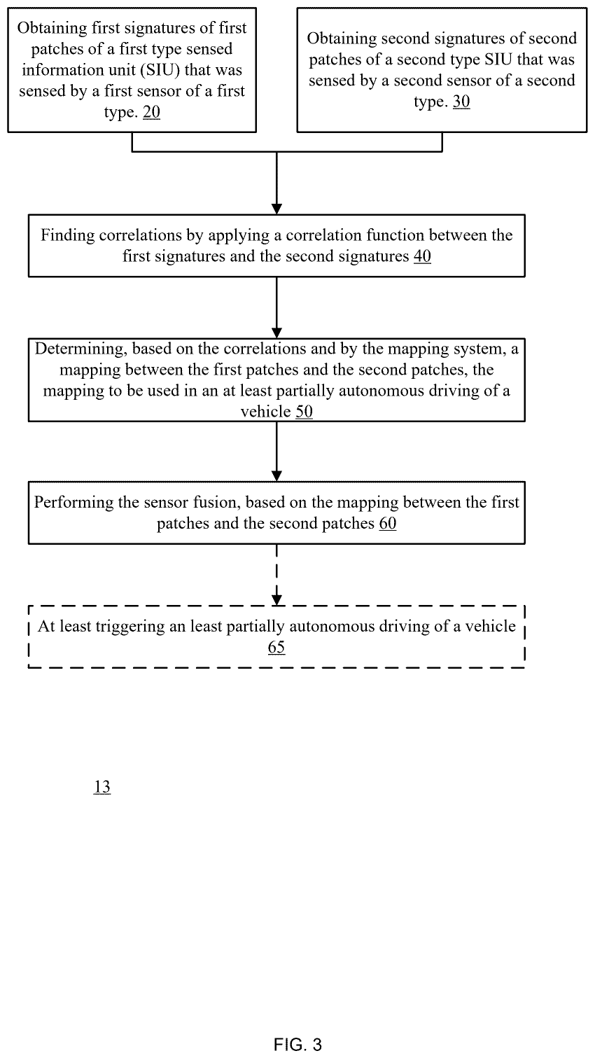

FIG. 3 illustrates an example of method 13 that differs from method 10 by including step 60 (following step 50) of performing the sensor fusion, based on the mapping between the first patches and the second patches.

According to an embodiment, step 60 is followed by step 65 at least triggering an least partially autonomous driving of a vehicle.

Step 65 may include at least one of:
Triggering an least partially autonomous driving of a vehicle.
Sending an instruction to at least one of an autonomous driving system and/or an ADAS system.
Sending a request to at least one of an autonomous driving system and/or an ADAS system.
Determining a driving related operation.
Triggering a determination of a driving related operation.

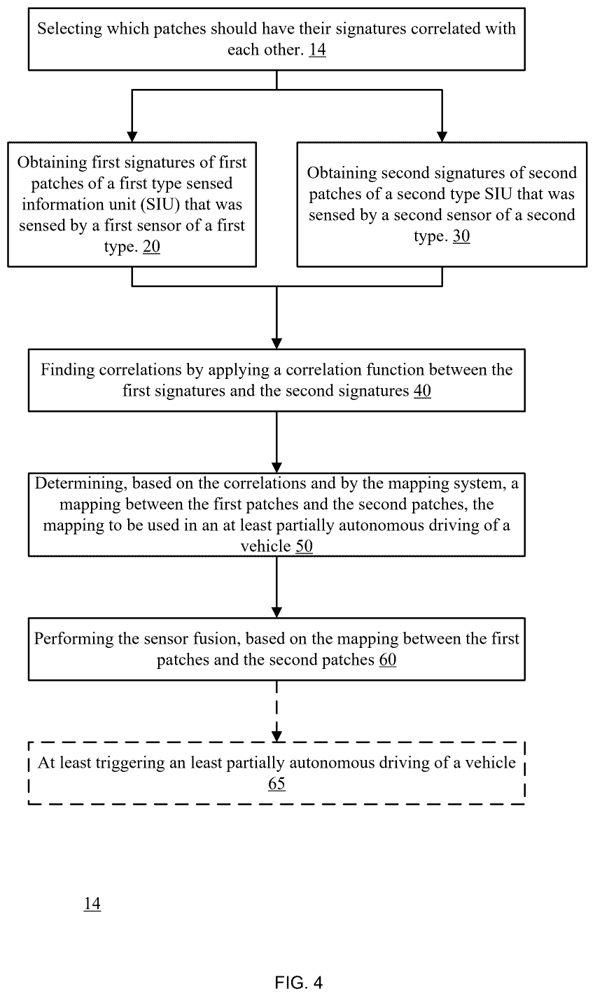

FIG. 4 illustrates an example of method 14 that differs from method 10 by including step 60 (following step 50) of performing the sensor fusion, based on the mapping between the first patches and the second patches.

According to an embodiment, step 60 is followed by step 65 at least triggering an least partially autonomous driving of a vehicle.

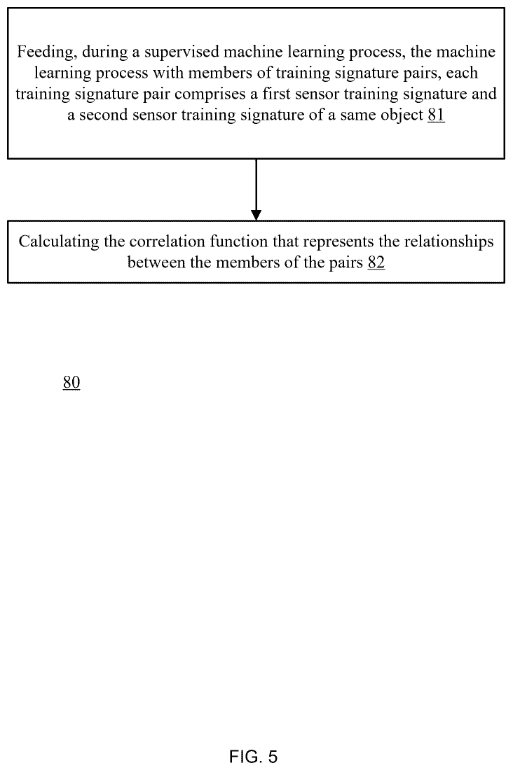

FIG. 5 illustrates an example of method 80 for calculating a correlation function.

According to an embodiment, method 80 includes step 81 of feeding, during a supervised machine learning process, the machine learning process with members of training signature pairs, each training signature pair comprises a first sensor training signature and a second sensor training signature of a same object.

Step 81 is followed by step 82 of calculating the correlation function that represents the relationships between the members of the pairs.

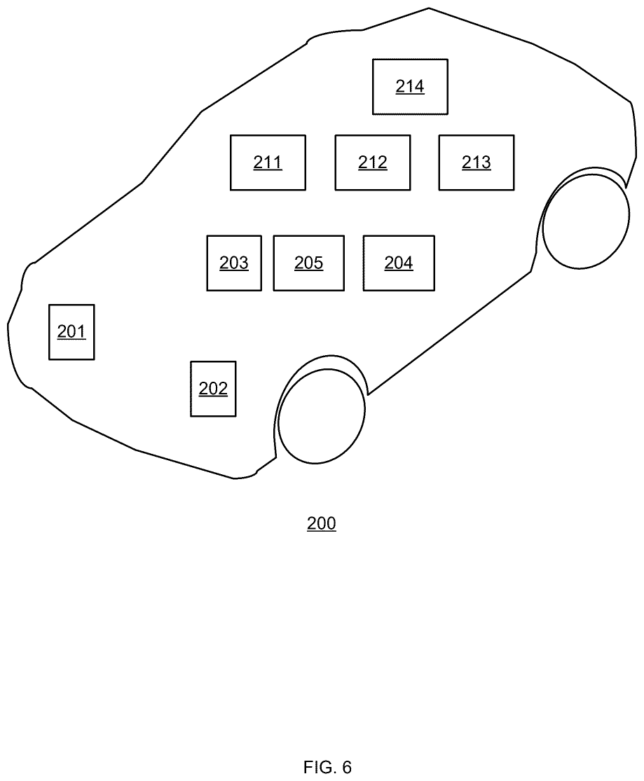

FIG. 6 illustrates an example of a vehicle 200.

According to an embodiment, vehicle 200 includes first sensor 201, second sensor 202, one or more processing circuits 203, communication unit 204, one or more memory units 205.

The one or more processing circuit 203 are configured to execute instructions and act as a mapping system 211, a fusion system 212, an autonomous driving system 213, an ADAS system 214, and the like.

The autonomous driving system 213 and/or the ADAS system 214 are configured to at least partially autonomously drive the vehicle—based, at least in part of the outcome of the sensor fusion. Other factors such as traffic laws, various driving related policies, and the like, may also impact the at least partially autonomously driving.

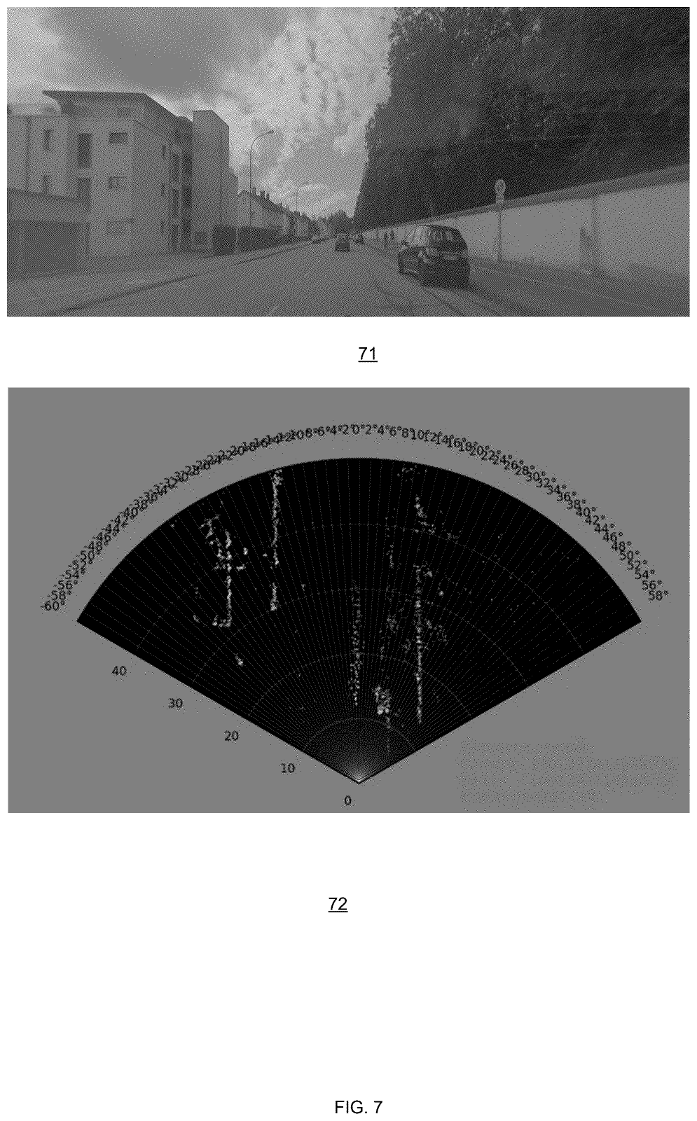

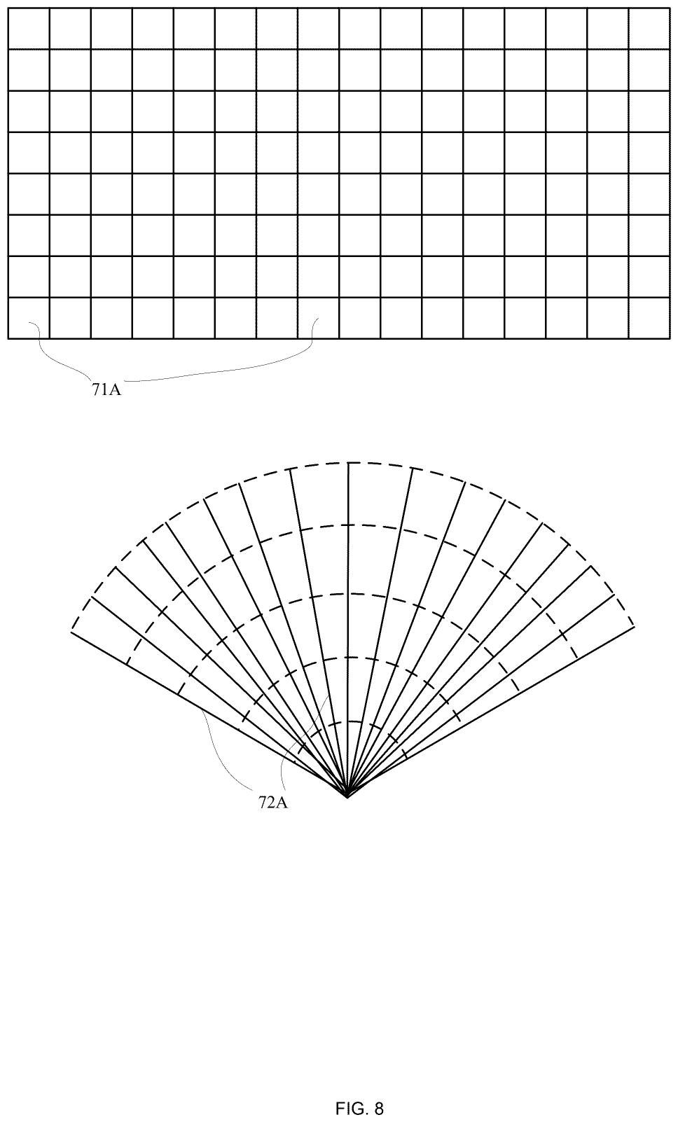

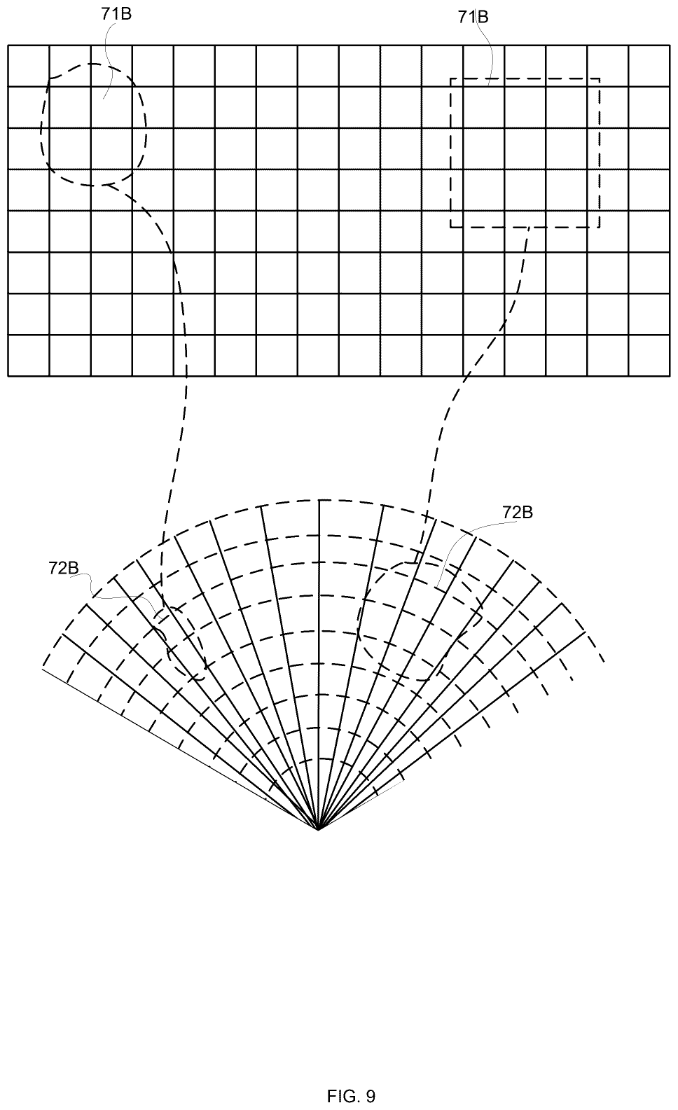

FIGS. 7-10 illustrate examples of a first SIU 71, a second SIU 72, first patches candidates 71A, second patches candidates 72A, first patches 71B, second patches 72B, first signatures 73A, second signatures 73B, correlation function 74, mapping 75, estimated mapping 76, and sensor fusing results 77.

A processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A computer-implemented method for sensor fusion in relation to at least partially autonomous driving of a vehicle, the method comprising:
obtaining first signatures of first patches of a first type sensed information unit (SIU) that was sensed by a first sensor of a first type;
obtaining second signatures of second patches of a second type SIU that was sensed by a second sensor of a second type, the second type differs from the first type; wherein the first sensor and the second sensor are associated with the vehicle;
finding correlations by applying a correlation function between the first signatures and the second signatures; wherein the finding is executed by a mapping system; and
determining, based on the correlations and by the mapping system, a mapping between the first patches and the second patches, the mapping to be used in an at least partially autonomous driving of a vehicle;
wherein the correlation function having been developed by applying a supervised machine learning process based on relationships between members of training signature pairs, each training signature pair comprises a first sensor training signature and a second sensor training signature of a same object.

2. The method according to claim 1, wherein the determining of the mapping comprises determining a projective transformation.

3. The method according to claim 2, wherein the determining of the mapping further comprises determining a profile of a road on which the vehicle propagates.

4. The method according to claim 3, wherein the determining of the mapping further comprises determining a first sensor orientation parameter.

5. The method according to claim 1, further comprising performing the sensor fusion.

6. The method according to claim 1, comprising selecting the first patches and the second patches, the first patches are selected from first patches candidates, the second patches are selected from second patches candidates.

7. The method according to claim 6, wherein the selecting is based on an estimated mapping between the first patches and the second patches.

8. The method according to claim 1, further comprising fusing content associated with pairs of patches, each pair comprises a first patch and a corresponding second patch that is mapped, according to the mapping, to the first patch.

9. A non-transitory computer readable medium storing instructions that, when executed by at least one processor, cause the at least one processor to perform operations for sensor fusion in relation to at least partially autonomous driving of a vehicle, the operations comprising:
obtaining first signatures of first patches of a first type sensed information unit (SIU) that was sensed by a first sensor of a first type;
obtaining second signatures of second patches of a second type SIU that was sensed by a second sensor of a second type, the second type differs from the first type; wherein the first sensor and the second sensor are associated with the vehicle;
finding correlations by applying a correlation function between the first signatures and the second signatures; and
determining, based on the correlations, a mapping between the first patches and the second patches, the mapping to be used in an at least partially autonomous driving of a vehicle;
wherein the correlation function having been developed by applying a supervised machine learning process based on relationships between members of training signature pairs, each training signature pair comprises a first sensor training signature and a second sensor training signature of a same object.
